(19) United States
(12) Patent Application Publication
(10) Pub. No.: US 2026/0143363 A1
(43) Pub. Date: May 21, 2026

(54) CONFLICT MANAGEMENT IN A NETWORK

(71) Applicant: Rakuten Mobile, Inc., Tokyo (JP)

(72) Inventors: Saurabh VERMA, Tokyo (JP); Masahiko NANRI, Tokyo (JP)

(73) Assignee: Rakuten Mobile, Inc., Tokyo (JP)

(21) Appl. No.: 18/955,341

(22) Filed: Nov. 21, 2024

(51) Int. Cl. H04W 24/04; H04L 41/0873; H04L 41/0894

(52) U.S. Cl. CPC H04W 24/04; H04L 41/0873; H04L 41/0894

(57) ABSTRACT

Provided are apparatus, method, and device for automatically manage conflicts in a network. According to example embodiments, the apparatus may comprise a near-real-time RIC (Near-RT RIC) that may be configured to: receive, from a first rApp, a first policy and a priority of the first policy; determine a first xApp for implementing the first policy; receive, from a second rApp, a second policy and a priority of the second policy; determine a second xApp for implementing the second policy; identify a conflict between the first policy and the second policy; and determine a strategy for the first xApp and the second xApp to implement the first policy and the second policy, respectively, based on the priority of the first policy and the priority of the second policy.

### FIELD

The present disclosure relates to management of conflicts in a telecommunications network.

### BACKGROUND

The information disclosed in this background section is only for enhancement of understanding of the general background of the disclosure and should not be taken as an acknowledgement or any form of suggestion that this information forms the prior art already known to a person skilled in the art.

A radio access network (RAN) is an important component in a telecommunications system, as it connects end-user devices (or user equipment) to other parts of the network. The RAN includes a combination of various network elements (NEs) that connect end-users to a core network. Traditionally, hardware and/or software of a particular RAN is vendor specific.

Open RAN (O-RAN) technology has emerged to enable multiple vendors to provide hardware and/or software to a telecommunications system. Since different vendors are involved, the type of hardware and/or software provided may also be different. That is, different types of NEs may be provided by different vendors, and depending on the specific service, the NE could be virtualized in software form (e.g., virtual machine (VM)-based), or could be in physical hardware form (e.g., non-VM based).

### SUMMARY

Example embodiments of the present disclosure automatically manage conflicts in a network. As such, example embodiments of the present disclosure allow for detection and management of conflicts at the Near-RT RIC/xApp level, thereby ensuring that all conflicts can be appropriately managed and reduced to minimize impact on network performance and quality of service (QoS).

According to example embodiments, an apparatus is provided. The apparatus may comprise a near-real-time RIC (Near-RT RIC) that may be configured to: receive, from a first rApp, a first policy and a priority of the first policy; determine a first xApp for implementing the first policy; receive, from a second rApp, a second policy and a priority of the second policy; determine a second xApp for implementing the second policy; identify a conflict between the first policy and the second policy; and determine a strategy for the first xApp and the second xApp to implement the first policy and the second policy, respectively, based on the priority of the first policy and the priority of the second policy.

According to example embodiments, a method is provided. The method may include: receiving, by a near-real-time RIC (Near-RT RIC) from a first rApp, a first policy and a priority of the first policy; determining, by the Near-RT RIC, a first xApp for implementing the first policy; receiving, by the Near-RT RIC from a second rApp, a second policy and a priority of the second policy; determining, by the Near-RT RIC, a second xApp for implementing the second policy; identifying, by the Near-RT RIC, a conflict between the first policy and the second policy; and determining, by the Near-RT RIC, a strategy for the first xApp and the second xApp to implement the first policy and the second policy, respectively, based on the priority of the first policy and the priority of the second policy.

According to example embodiments, a non-transitory computer-readable recording medium is provided. The non-transitory computer-readable recording medium may have recorded thereon instructions executable by an apparatus comprising a near-real-time RIC (Near-RT RIC) to cause the Near-RT RIC to perform a method including: receiving, from a first rApp, a first policy and a priority of the first policy; determining a first xApp for implementing the first policy; receiving, from a second rApp, a second policy and a priority of the second policy; determining a second xApp for implementing the second policy; determining a second xApp for implementing the second policy; identifying a conflict between the first policy and the second policy; and determining a strategy for the first xApp and the second xApp to implement the first policy and the second policy, respectively, based on the priority of the first policy and the priority of the second policy.

Additional aspects will be set forth in part in the description that follows and, in part, will be apparent from the description, or may be realized by practice of the presented embodiments of the disclosure.

### BRIEF DESCRIPTION OF THE DRAWINGS

Features, aspects, and advantages of embodiments of the disclosure will be described below with reference to the accompanying drawings, in which like reference numerals denote like elements, and wherein:

FIG. 1 illustrates an O-RAN architecture in the related art;

FIG. 2 illustrates a flow diagram of an example method for performing conflict management, according to one or more example embodiments;

FIG. 3 illustrates an example plurality of priority levels, according to one or more example embodiments;

FIG. 4 illustrates example logical linkages between various rApps and xApps, according to one or more example embodiments;

FIG. 5A to FIG. 5C illustrate a flow sequence of an example use case for managing conflicts, according to one or more example embodiments;

FIG. 6 illustrates an example policy state diagram, according to one or more example embodiments; and

FIG. 7 illustrates a diagram of example components of a device for implementing one or more example embodiments.

### DETAILED DESCRIPTION

The following detailed description of example embodiments refers to the accompanying drawings. The present disclosure provides illustrations and descriptions, but is not intended to be exhaustive or to limit the implementations to the precise form disclosed. Modifications and variations are possible in light of the present disclosure or may be acquired from practice of the implementations. Further, one or more features or components of one embodiment may be incorporated into or combined with another embodiment (or one or more features of another embodiment). Additionally, the flowchart and description of operations provided below relate to at least one of the embodiments in the present disclosure. It should be noted that it is possible to make other embodiments that do not exactly match the flowchart and its description. It is understood that in other embodiments one or more operations may be omitted, one or more operations may be added, one or more operations may be performed simultaneously (at least in part). Further, the order of one or more operations may be switched, as long as these modifications may not affect the resulting scope of the invention.

It will be apparent that systems and/or methods, described herein, may be implemented in different forms of hardware, software, or a combination of hardware and software. The actual specialized control hardware or software code used to implement these systems and/or methods should not limit their implementations. Thus, the operation and behavior of the systems and/or methods are described herein without reference to specific software code. It is understood that software and hardware may be designed to implement the systems and/or methods based on the description herein.

Even though particular combinations of features are recited in the claims and/or disclosed in the specification, the particular combinations are not intended to limit the disclosure of implementations. In fact, many of these features may be combined in ways not specifically recited in the claims and/or disclosed in the specification. Even if a dependent claim directly depends on only one claim, the present disclosure may indicate that the dependent claim is dependent on other claims in the claim set.

No element, act, or instruction used herein should be construed as critical or essential unless explicitly described as such. Also, as used herein, the articles “a” and “an” (in other words, nouns not mentioned in the plural) are intended to include one or more items, and may be used interchangeably with “one or more.” Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B],” “[A] and/or [B],” or “at least one of [A] or [B]” are to be understood as including only A, only B, or both A and B. Further still, where only one item is intended, the term “one” or similar language is used.

The foregoing disclosure provides illustration and description but is not intended to be exhaustive or to limit the implementations to the precise form disclosed. Modifications and variations are possible in light of the above disclosure or may be acquired from practice of the implementations.

It shall be noted that, descriptions of example embodiments of the present disclosure may include terms and names defined in one or more standard organizations, such as the 3rd Generation Partnership Project (3GPP) standard organization, the European Telecommunications Standards Institute (ETSI) standard organization, the Open Radio Access Network (O-RAN) Alliance standard organization, and the like. For instance, the terms “rApp”, “xApp”, “A1 interface”, “O1 interface”, “E2 interface”, and the like, as well as the associated features and operations, are to be interpreted as consistent with those specified in one or more technical specifications.

Further, although some embodiments of the present disclosure may be described herein with reference specific components of 5G system, it can be understood that the scope of the present disclosure should not be limited thereto. Specifically, example embodiments of the present disclosure may also apply to any suitable network elements in any suitable telecommunications system, such as a 4G LTE system, a 6G system, and the like, without departing from the scope of the present disclosure.

As described above, O-RAN technology has emerged to enable multiple vendors to provide hardware and/or software to a telecommunications system. To this end, O-RAN disaggregates the RAN functions into a centralized unit (CU), a distributed unit (DU), and a radio unit (RU). The CU may be a logical node for hosting Radio Resource Control (RRC), Service Data Adaptation Protocol (SDAP), and/or Packet Data Convergence Protocol (PDCP) sublayers of the RAN. The DU may be a logical node hosting Radio Link Control (RLC), Media Access Control (MAC), and Physical (PHY) sublayers of the RAN. The RU may be a physical node that converts radio signals from antennas to digital signals that can be transmitted over the Front Haul to a DU. Because these entities have open protocols and interfaces between them, they can be developed by different vendors.

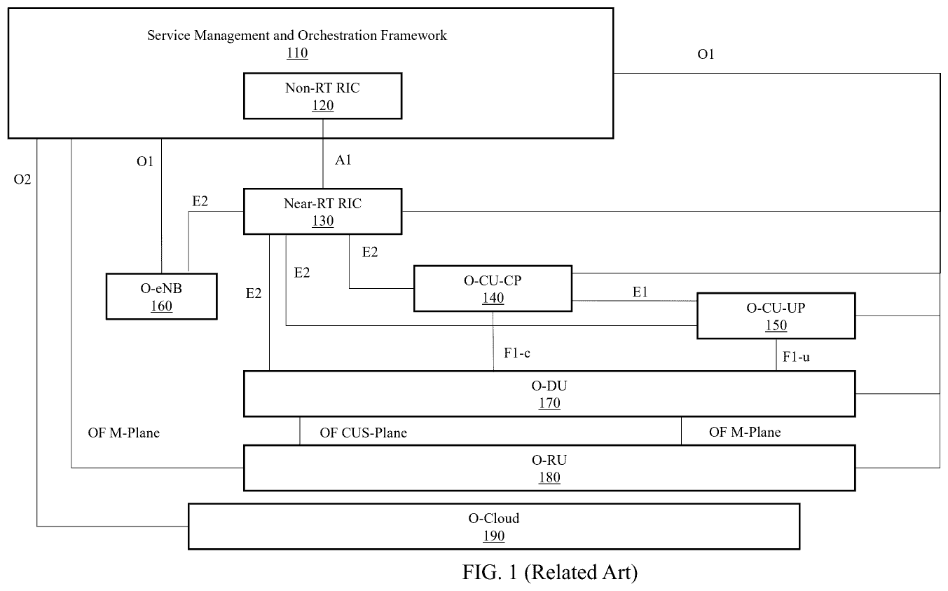

FIG. 1 illustrates an O-RAN architecture in the related art. As illustrated in FIG. 1, the O-RAN architecture may include at least one Service Management and Orchestration (SMO) framework 110 that includes at least one non-real-time RAN Intelligent Controller (Non-RT RIC) 120, at least one near-real-time RIC (Near-RT RIC) 130, at least one O-RAN Centralized Unit (O-CU) that may be disaggregated into an O-CU control plane (O-CU-CP) 140 and an O-CU user plane (O-CU-UP) 150, at least one open evolved NodeB (O-eNB), at least one O-RAN Distributed Unit (O-DU) 170, at least one O-RAN Radio Unit (O-RU) 180, and at least one O-RAN Cloud (O-Cloud) 190. The components may be communicatively coupled to another component(s) within the O-RAN architecture via a respective interface(s).

It is contemplated that the O-RAN architecture may include more/fewer components than illustrated, and/or may be configured in a different manner, without departing from the scope of the present disclosure. For instance, in some implementations, the O-RAN architecture may further include a plurality of O-DUs, a plurality of O-RUs, and the like.

The RAN functions in the system may be controlled and optimized by at least one RIC. The RIC may be a software-defined component that implements modular applications to facilitate the multivendor operability, as well as to automate and optimize RAN operations. As shown in FIG. 1, the RIC may be divided into two types, i.e., the Non-RT RIC 120 and the Near-RT RIC 130. In the following, descriptions of the Non-RT RIC 120 are provided, followed by the descriptions of the Near-RT RIC 130.

The Non-RT RIC 120 may refer to a logical function within the SMO framework 110 that drives the content carried across the A1 interface to enable non-real-time control and optimization of RAN elements and resources. The A1 interface may refer to a logical interface between the Non-RT RIC 120 and the Near-RT RIC 130, which enables the Non-RT RIC 120 to provide policy-based guidance (objective, resource) to the Near-RT RIC 130 and enables the Near-RT RIC 130 to provide one or more feedbacks to the Non-RT RIC 120 to monitor the status of one or more policies.

In some example, implementations, the Non-RT RIC 120 may be the control point of a non-real-time control loop and may operate on a timescale greater than 1 second within the SMO framework 110. The functionalities of the Non-RT RIC 120 may include, for example, providing policy-based guidance and enrichment across the A1 interface, performing data analytics, Artificial Intelligence/Machine Learning (AI/ML) models training and inference for RAN optimization, and/or recommending configuration management actions. As further described below, the Non-RT RIC 120 may access or communicate with other SMO framework functionalities or components via A1 interface, O1 interface, O2 interface, and one or more interfaces associated with one or more open fronthaul planes.

According to example embodiments, the functionalities of the Non-RT RIC 120 may be implemented through at least one modular, Non-RT RIC application, such as an rApp (not shown). The rApp may leverage the functionalities available in the SMO framework 110 and/or the Non-RT RIC 120 to provide value added services related to RAN operation and optimization, such as policy management, radio resource management, data analytics, and providing enrichment information. In some implementations, the Non-RT RIC 120 may implement a plurality of rApps.

According to example embodiments, the Non-RT RIC 120 may include a Non-RT RIC framework that may be configured to provide or implement one or more services to the rApp through R1 interface. The R1 interface may refer to an open logical interface between the rApp and the Non-RT RIC framework. The R1 interface supports the exchange of data or information, as well as the collection and delivery of data between the rApp and the Non-RT RIC framework. The one or more services, which may also be referred to as “R1 services” herein, may include policy management services, service registration and discovery services, authentication and authorization services, AI/ML workflow services, RAN OAM-related services, A1 related services, and O2 related services. The R1 interface allows multi-vendor rApps to manage or add the R1 services, and facilitate inter-connection between rApps and Non-RT RIC framework supplied by different vendors.

According to example embodiments, the rApp may be configured to manage one or more policies that are provided to the Near-RT RIC 130 over the A1 interface. Said policies may be referred to as “A1 policies” herein, and are declarative policies that contain statements on policy objectives and policy resources applicable to one or more network nodes (e.g., one or more UEs, one or more network cells, etc.). Specifically, the one or more A1 policies may consist of a scope identifier and one or more policy statements. The scope identifier may represent what the policy statements are to be applied on (e.g. UEs, QoS flows, or cells). The policy statements may define the goals or objectives of the policy and may include information associated with policy objectives and policy resources. In an example, the A1 policies may include Quality of Service (QoS) requirements and Energy Saving (ES) requirements, specifying, for example, new QoS Class Identifier (QCI) parameters that an xApp should follow/utilize, and energy saving aggressiveness. By including the policy objectives in the policy statements, the quality of experience can be optimized for UEs or QoS flows that are identified either explicitly by, for example, a UE identifier or a QoS identifier, or implicitly by, for example, a group identifier from which the Near-RT RIC 230 can deduce a set of UEs. On the other hand, by including the policy resources in the policy statements, UEs can be configured to avoid certain cells and/or the radio network can be optimized in specific areas.

The rApp (or the Non-RT RIC framework within the Non-RT RIC 120) may provide the one or more A1 policies to the Near-RT RIC 130, thereby providing guidance to the Near-RT RIC 130 towards one or more objectives or goals defined in the RAN intent. The RAN intent may refer to the high-level operational or business goal(s) to be achieved by the RAN, which may be defined by one or more desired service level agreements (SLAs) that the RAN is to fulfill for all users or for a subset of users in a given area over at least a predefined period of time.

According to example embodiments, the rApp may be configured to perform one or more policy management operations to provision and manage one or more A1 policies in the Near-RT RIC 130. Specifically, the rApp may be configured to create, update and delete one or more A1 policies in the Near-RT RIC 130. For instance, the rApp may query the presence, content and run-time status of one or more A1 policies in the Near-RT RIC 130.

According to example embodiments, the rApp may be configured to receive, from the Near-RT RIC via the A1 interface, one or more feedback associated with one or more A1 policies (“A1 policy feedback” herein). Similarly, the rApp may be configured to receive one or more observables (e.g., events, counters, etc.) provided by the O-CU (O-CU-CP 140/O-CU-UP 150), the O-DU 170, and/or the O-RU 180 over the O1 interface. Accordingly, the rApp may be configured to continuously (or periodically) manage the one or more A1 policies based on the A1 policy feedback(s) and/or the observables provided over the O1 interface. For instance, the rApp may continuously (or periodically) evaluate the impact or effectiveness of the one or more A1 policies towards the fulfillment of the RAN intent and then configure or update the one or more A1 policies accordingly.

In addition to the communication with the Near-RT-RIC 130 via the A1 interface, the SMO framework 110 (as well as the Non-RT RIC 120 and/or the rApp implemented therein) may communicate with the O-CU (O-CU-CP 140/O-CU-UP 150), the O-eNB 160, the O-DU 170, and the O-RU 180 via the O1 interface. In this regard, the O1 interface may refer to a logical interface between the SMO framework 110, the Near-RT RIC 130, the O-CU (O-CU-CP 140/O-CU-UP 150), the O-eNB 160, the O-DU 170, and the O-RU 180, which enables the SMO framework 110 (as well as the Non-RT RIC 120 and the rApp implemented therein) to provide Fault, Configuration, Accounting, Performance, and Security (FCAPS) and other management operations, such as network monitoring, network discovery, and the like, to the Near-RT RIC 130, the O-CU (O-CU-CP 140/O-CU-UP 150), the O-eNB 160, the O-DU 170, and/or the O-RU 180. Additionally, the O1 interface enables the Near-RT RIC 130, the O-CU (O-CU-CP 140/O-CU-UP 150), the O-eNB 160, the O-DU 170, and/or the O-RU 180 to provide information or observable(s) that may be utilized by the Non-RT RIC 120 (or the rApp) to manage the A1 policy(s), to train one or more AI/ML models, and the like.

Further, the SMO framework 110 (as well as the Non-RT RIC 120 and/or the rApp implemented therein) may communicate with the O-Cloud 190 via the O2 interface. In this regard, the O2 interface may refer to a logical interface between the SMO framework 110 and the O-Cloud 190, which may be a collection of physical RAN nodes that host the Non-RT RIC 120, the Near-RT RIC 130, the O-CU (O-CU-CP 140/O-CU-UP 150), the O-eNB 160, and the O-DU 170, the supporting software components (e.g., the operating systems and runtime environments), and the SMO framework 110 itself. In other words, the SMO framework 110 may manage the O-Cloud 190 from within, and the O2 interface may be the interface between the SMO framework 110 and the O-Cloud 190 it resides in. Through the O2 interface, the SMO framework 110 (as well as the Non-RT RIC 120 and/or the rApp implemented therein) may provide infrastructure management services (IMS) and deployment management services (DMS) for the O-Cloud 190.

Furthermore, the SMO framework 110 (as well as the Non-RT RIC 120 and/or the rApp implemented therein) may communicate with the O-RU 180 via an open fronthaul (O-FH) management plane (M-Plane) interface. In this regard, the O-FH M-Plane may enable the SMO framework 110 (as well as the Non-RT RIC 120 and/or the rApp implemented therein) to perform one or more FCAPS operations on the O-RU 180.

Next, the descriptions of the Near-RT RIC 130 are provided. The Near-RT RIC 130 may refer to a logical function that enables near-real-time control and optimization of RAN elements and resources. For instance, the Near-RT RIC 130 may provide the near-real-time control and optimization via fine-grained (e.g., UE basis, Cell basis) data collection and actions over the E2 interface. In some example, implementations, the Near-RT RIC 130 may operate on a timescale between 10 milliseconds and 1 second and may be coupled with the O-CU (O-CU-CP 140/O-CU-UP 150), the O-eNB 160, and the O-DU 170 via the E2 interface. The Near-RT RIC 130 may use the E2 interface to control the underlying RAN elements (E2 nodes/network functions (NFs)) over a near-real-time control loop.

According to example embodiments, the Near-RT RIC 130 may monitor, suspend/stop, override, and control the E2 nodes (e.g., the O-CU (O-CU-CP 140/O-CU-UP 150), the O-eNB 160, and the O-DU 170, etc.) via one or more policies (e.g., A1 policies). For example, the Near-RT RIC 130 may receive the one or more A1 policies from the Non-RT RIC 120 (or the rApp implemented therein) and then configure or set one or more policy parameters associated with the one or more A1 policies on activated functions of the E2 nodes. Further, the Near-RT RIC 130 may host one or more applications, such as the xApp (not shown), to implement functions such as quality of service (QoS) optimization, mobility optimization, slicing optimization, interference mitigation, load balancing, security, and the like.

In this regard, the xApp may consist of one or more microservices, which may be independent of the Near-RT RIC 130 and may be provided by any third party. The E2 interface enables a direct association between the xApp and other RAN functionalities (e.g., the O-CU (O-CU-CP 140/O-CU-UP 150), the O-eNB 160, and the O-DU 170, etc.), thereby enabling the xApp to provide information or data to the RAN functionalities for further utilization. According to example embodiments, the Near-RT RIC 130 may consist of multiple xApps and a set of platform functions that are commonly used to support the specific functions hosted by the multiple xApps. In this regard, the Near-RT RIC platform may communicate with the xApp(s) via one or more application programming interfaces (APIs). Further, the Near-RT RIC platform may be configured to route A1 policy management messages to the registered xApps based on A1 policy type and operator policies.

According to example embodiments, the xApp may be configured to adjust or configure one or more of the above-described parameters and optimize said one or more parameters according to the current A1 policy(s) and the current network condition(s) (e.g., load, energy consumption, etc.), thereby providing controlling latency and throughput that fulfills the QoS requirement(s) and/or the energy saving requirement(s).

According to example embodiments, the xApp may be configured to perform the one or more control operations via the E2 interface. For instance, the xApp may be configured to perform O-DU E2 control and send one or more associated commands to the O-DU 170. As another example, the xApp may be configured to perform O-CU E2 control, where the O-CU (O-CU-CP 140/O-CU-UP 150) may send the one or more associated commands to the O-DU 170, and the O-DU 170 may then control the associated O-RU(s) or cell(s). Accordingly, the O-DU 170 may in the end shape the E2 control and policy.

Next, the descriptions of the O-CU (O-CU-CP 140/O-CU-UP 150), the O-DU 170, and the O-RU 180 are provided. Generally, the O-CU (O-CU-CP 140/O-CU-UP 150), the O-DU 170, and the O-RU 180 may constitute a base station, such as a gNodeB (gNB) of 5G NR or a node in Next Generation Radio Access Network (NG-RAN), an Evolved Node B (eNodeB) of a 4G LTE network, a base station of a 6G network, and the like.

The communication between the O-CU and the O-DU 170 may be performed via an F1 interface, in particular, the communication between the O-CU-CP 140 and the O-DU 170 may be performed via an F1-c interface, while the communication between the O-CU-UP 150 and the O-DU 170 may be performed via an F1-u interface. The communication between the O-DU 170 and the O-RU 180 may be performed via one or more O-FH Control (C), User (U), Synchronization (S), and Management (M) plane interfaces. In some implementations, the C, U, and S planes may be consolidated and referred to as the “CUS-plane”. According to example embodiments, the system may include a plurality of O-DUs 170, and the O-CU may be communicatively coupled to the plurality of O-DUs via the F1 interface. Similarly, the system may include a plurality of O-RUs 180, and the O-DU 170 may be communicatively coupled to the plurality of O-RUs via one or more of the O-FH C/U/S/M plane interfaces.

According to example embodiments, the O-CU (O-CU-CP 140/O-CU-UP 150) and the O-DU 170 may be defined in software form and may be deployed in one or more network nodes. For instance, the O-CU (O-CU-CP 140/O-CU-UP 150) and the O-DU 170 may be deployed in one or more servers in the form of virtualized network function (VNF), containerized and/or cloud-native function (CNF), and the like. According to example embodiments, the O-CU (O-CU-CP 140/O-CU-UP 150) and the O-DU 170 may be deployed in the same network node (e.g., same server) and/or may be located at a similar geographical location (e.g., be deployed in different servers in the same data center). According to example embodiments, the O-CU (O-CU-CP 140/O-CU-UP 150) and the O-DU 170 may be deployed in different network nodes and/or may be located at different geographical locations. For instance, the O-CU (O-CU-CP 140/O-CU-UP 150) may be deployed in one or more central servers (i.e., servers in one or more central data centers), and the O-DU 170 may be deployed in one or more edge servers (i.e., servers in one or more edge data centers).

The O-DU 170 may receive radio signals from an end user (via one or more UEs and one or more cells) and may provide operation or support for lower layers of protocol stacks (e.g., RLC layer, MAC layer, Physical Layer, etc.) accordingly. As an example, the O-DU 170 may perform one or more scheduling operations. The O-CU (O-CU-CP 140/O-CU-UP 150) may communicatively couple the O-DU 170 to a core network (e.g., 4G Evolved Packet Core (EPC) network, 5G Core network, etc.) and may receive the radio signals from the O-DU 170, thereby providing operation or support for higher layers of protocol stacks (e.g., PDCP layer, RRC layer, etc.) accordingly.

As described above, according to example embodiments, the O-CU may include an O-CU control plane (O-CU-CP) 140 and an O-CU user plane (O-CU-UP) 150. The O-CU-CP 140 may refer to the logical node that hosts or implements the RRC and the control plane part of the PDCP protocol, and may be responsible for managing the signaling between the core network and the radio network, handling tasks such as session management, radio bearer control, and mobility management. On the other hand, the O-CU-UP 150 may refer to the logical node that hosts or implements the user plane part of the PDCP protocol and the SDAP protocol, and may be responsible for managing the data traffic and the transmission of user data packets. The O-CU-CP 140 and the O-CU-UP 150 may be coupled to each other via the E1 interface.

Further, a single O-DU 170 may host or serve multiple network cells formed by multiple O-RUs 180. According to example embodiments, the O-DU 170 may implement various radio technologies, such as massive multiple-input multiple-output (MIMO), beamforming, and the like, to optimize radio communication among the multiple cells and the O-CU (O-CU-CP 140/O-CU-UP 150). In some implementations, the O-DU 170 may concurrently host or serve hundreds (e.g., 512, etc.) of cells at a time.

The O-RU 180 may be a physical node that converts radio signals from antennas to digital signals that can be transmitted over the Front Haul to the O-DU 170. In this regard, a network cell described herein may correspond to one or more radio units responsible for providing wireless coverage and signal transmission within the network cell. The network cell may include a macro cell, a micro cell, a pico cell, a femto cell, and/or any other suitable type of network cell. Each of the cells may have an associated coverage area, in which the O-RU 180, at least one antenna system, and any other suitable type of transport network element (TNE), may be deployed therein.

According to example embodiments, the O-DU 170 may be configured to control or instruct the associated O-RU(s) via one or more of the O-FH C/U/S/M plane interfaces. For instance, the O-DU 170 may instruct the O-RU 180 to enter the sleep mode via the O-FH C/U/S plane interfaces. On the other hand, the capability exchange between the O-DU 170 and the O-RU 180 may be performed via the O-FH M-plane interface. As an example, the O-RU 180 may inform the O-DU 170 of the amount of time it requires to maintain in the sleep mode in order to save an amount of energy.

In this regard, conflict management is an important aspect of O-RAN in order to ensure that high network performance and high quality of service (QoS) can be achieved and maintained. In particular, as described above, the O-RAN architecture may involve implementations of various rApps at the Non-RT RIC. Such rApps may receive intent policies from the SMO, and may implement such intent policies via the xApps at the Near-RT RIC. In this regard, since the rApps may be independent from each other in development and execution, the implementation of various intent policies by various rApps may result in conflict of interest at the xApp level. For example, an xApp may receive and implement a policy from an rApp to perform traffic steering at an E2 node, while another xApp may implement a policy from another rApp to perform energy saving measures at the same E2 node at the same time.

In the related art, while there are some mechanisms to manage conflicts at the SMO/Non-RT-RIC/rApp level, there is no mechanism for resolving conflicts at the Near-RT RIC/xApp level, where it is still possible for xApps to simply continue to attempt to implement the conflicting policies resulting in suboptimal network performance.

Accordingly, system, methods, devices, and the like, provided in the example embodiments of the present disclosure automatically manage conflicts in a network.

According to example embodiments, a Near-RT RIC may receive a first policy with its priority and a second policy with its priority from a first rApp and a second rApp, respectively. The Near-RT RIC may then determine a first xApp and a second xApp that should implement the first policy and the second policy, respectively, where the Near-RT RIC may identify a conflict between the implementation of the first policy by the first xApp and the implementation of the second policy by the second xApp. Accordingly, the Near-RT RIC determine a strategy for the first xApp and the second xApp to implement the first policy and the second policy, respectively, based on the priority of the first policy and the priority of the second policy.

Ultimately, example embodiments of the present disclosure automatically manage conflicts in a network, which allows for detection and management of conflicts at the Near-RT RIC/xApp level, thereby ensuring that all conflicts can be appropriately managed and reduced to minimize impact on network performance and quality of service (QoS).

It is contemplated that features, advantages, and significances of example embodiments described hereinabove are merely a portion of the present disclosure, and are not intended to be exhaustive or to limit the scope of the present disclosure.

Further descriptions of the features, components, configuration, operations, and implementations of the system of the present disclosure, according to one or more example embodiments, are provided in the following.

### Example Operations for Managing Conflicts in the Present Disclosure

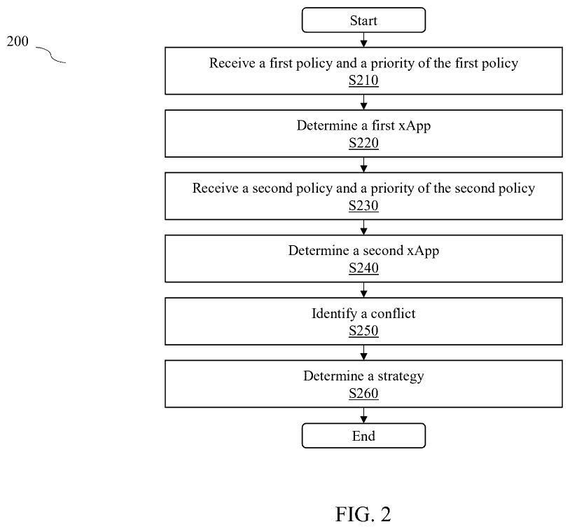

In the following, several example operations are performable by the apparatus of one or more example embodiments of the present disclosure are described with reference to FIG. 2 to FIG. 6.

FIG. 2 illustrates a flow diagram of an example method 200 for performing conflict management, according to one or more example embodiments. One or more operations in method 200 may be performed by the apparatus of one or more example embodiments of the present disclosure, where the apparatus may be configured to manage conflicts in a network. According to example embodiments, the apparatus may comprise a Near-RT RIC.

As illustrated in FIG. 2, at operation S210, the apparatus may be configured to receive a first policy and a priority of the first policy. The first policy and the priority of the first policy may be received from a first rApp.

According to example embodiments, the priority of the first policy may correspond to one of a plurality of priority levels. The plurality of priority levels may include: a first level specifying that a policy can pre-empt all other policies; a second level specifying that a policy cannot be deferred or be cancelled; a third level specifying that a policy can be deferred but cannot be cancelled; and a fourth level specifying that a policy can be deferred or cancelled.

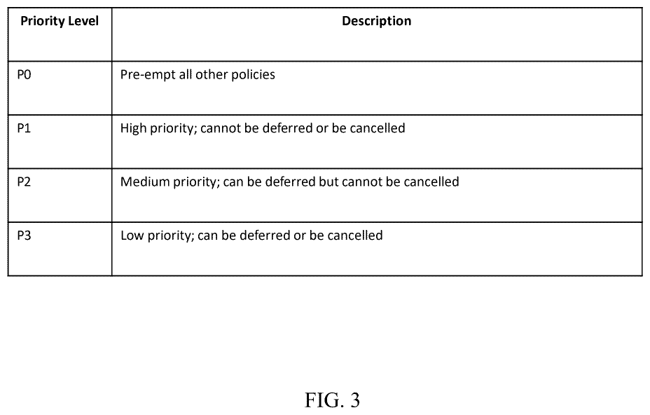

FIG. 3 illustrates an example plurality of priority levels, according to one or more example embodiments. As shown in FIG. 3, the plurality of priority levels may include a first level (P0), a second level (P1), a third level (P2), and a fourth level (P3), although it is understood that the plurality of priority levels may include more or less levels than as illustrated in FIG. 3, and/or may be arranged and specified in a manner different from as illustrated in FIG. 3, without departing from the scope of the present disclosure.

The first level may specify that a policy (e.g., the first policy) can pre-empt all other policies. In particular, the first level may specify that a policy associated with the first level of the plurality of priority levels may be implemented/executed regardless of the level of the plurality of priority levels of a conflicting policy.

The second level (P1) may specify that a policy (e.g., the first policy) has a high priority and cannot be deferred or cancelled.

The third level (P2) may specify that a policy (e.g., the first policy) has a medium priority, and can be deferred but cannot be cancelled.

The fourth level (P3) may specify that a policy (e.g., the first policy) has a low priority, and can be deferred or cancelled.

It is understood that the present disclosure is not limited in how the plurality of priority levels are defined. For example, the plurality of priority levels may be predefined by a user (e.g., network operator). In another example, the plurality of priority levels may be dynamically defined by the SMO/Non-RT RIC using a machine learning/artificial intelligence methods.

Similarly, the present disclosure is not limited in how the priority is determined for a particular policy. For example, the priority of the first policy may be dynamically determined by the SMO/Non-RT RIC/rApp using a machine learning/artificial intelligence methods based on RAN intent, feedback, and predefined guidelines. In particular, the SMO may be configured to create a policy and assign a priority to such policy based on one or more requirements (e.g., quality of service (QoS) requirement(s), energy saving requirement(s), etc.), RAN intents, feedback (e.g., feedback via gNB function exposure via E2 interface, policy type exposure through xApp via A1 interface, and the like), and the like, where the created policy and the assigned priority may be stored and registered in a policy catalogue at the SMO. The SMO may then utilize an rApp coordination function to assign a particular rApp to manage a particular policy, where such particular rApp may then obtain the particular policy and the assigned priority from the policy catalogue.

According to example embodiments, the first policy and the priority of the first policy may be specified in an xApp execution context received from the first rApp. It is understood that the xApp execution context may refer to an instruction, code, environment, and the like that is provided from an rApp to an xApp as part of a policy push from the rApp to the Near-RT RIC/xApp.

According to example embodiments, the first policy may be specified in the xApp execution context in the form of a policy context, which may comprise policy types, scope identifiers, policy statements, and the like. Similarly, the priority of the first policy may be specified in the xApp execution context in the form of an rApp context, which may comprise an intent of the first policy and a priority of the intent of the first policy. The method then proceeds to operation S220.

At operation S220, the apparatus may be configured to determine a first xApp for implementing the first policy. According to example embodiments, the apparatus may be configured to determine the first xApp by creating the first xApp to implement the first policy. According to example embodiments, the apparatus may be configured to determine the first xApp by selecting an xApp from a plurality of xApps currently being deployed at the Near-RT RIC.

In this regard, by receiving an xApp execution context from the first rApp (which specifies the first policy and the priority of the first policy) and determining the first xApp for implementing the first policy, a logical linkage representing a relationship between the first rApp and the first xApp may be established, where the context of a policy (i.e., the priority) may be maintained from the SMO to the rApp, and then to the xApp.

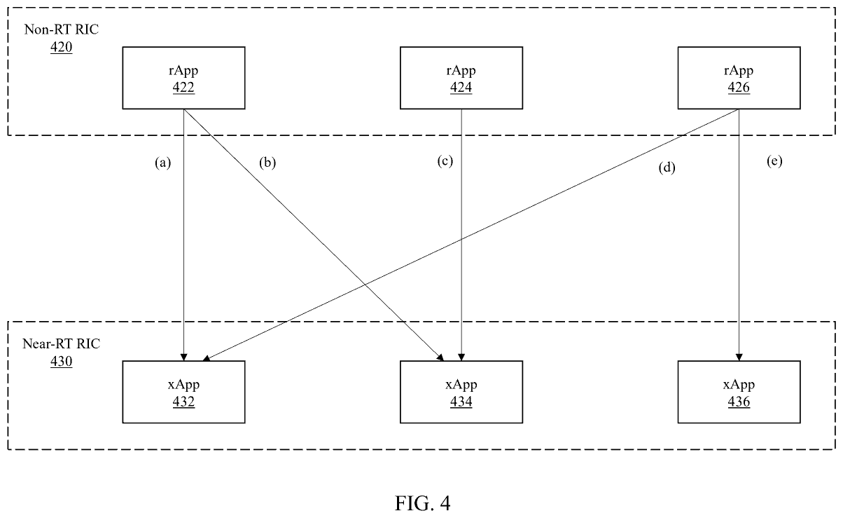

FIG. 4 illustrates example logical linkages between various rApps and xApps, according to one or more example embodiments. As shown in FIG. 4, a Non-RT RIC 420 may include a plurality of rApps 422,424,426, and a Near-RT RIC 430 may include a plurality of xApps 432,434,436. The Non-RT RIC 420 and the Near-RT RIC 430 may be similar to the Non-RT RIC 120 and the Near-RT RIC 130 described above in relation to FIG. 1.

Here, the rApp 422 may provide an xApp execution context specifying a policy A and the priority of policy A, where the Near RT-RIC may then create xApp 432 to implement policy A, in the similar manner as described above in relation to operations S210 and S220. Accordingly, a logical linkage may be established between the rApp 422 and the xApp 432 for implementing policy A, which is shown as arrow (a) in FIG. 4. Similar explanation applies to logical linkage (c) established between the rApp 424 and the xApp 434, and logical linkage (e) established between the rApp 426 and the xApp 436.

Further, the rApp 422 may provide another xApp execution context specifying a policy B and the priority of policy B, where the Near RT-RIC may then select xApp 434 to implement policy B. Accordingly, a logical linkage may be established between the rApp 422 and the xApp 434 for implementing policy B, which is shown as arrow (b) in FIG. 4. Similar explanation applies to logical linkage (d) established between the rApp 426 and the xApp 432. The method then proceeds to operation S230.

At operation S230, the apparatus may be configured to receive a second policy and a priority of the second policy. The second policy may be different from the first policy. Further, the second policy and the priority of the second policy may be received from a second rApp, in the similar manner as described above in relation to operation S210. The method then proceeds to operation S240.

At operation S240, the apparatus may be configured to determine a second xApp for implementing the second policy, in the similar manner as described above in relation to operation S220.

According to example embodiments, the second rApp may be different from the first rApp, while the second xApp may be the same as the first xApp or be different from the first xApp. For example, returning to FIG. 4, the first rApp may correspond to rApp 422 and the second rApp may correspond to rApp 426, where the first xApp may correspond to xApp 432 with logical linkage (a) established between rApp 422 and xApp 432. In this regard, the second xApp may also correspond to xApp 432, such that a logical linkage (d) is established between rApp 426 and xApp 432. Alternatively, the second xApp may instead correspond to xApp 436, such that a logical linkage (e) is established between rApp 426 and xApp 432.

Alternatively, according to example embodiments, the second xApp may be different from the first xApp, while the second rApp may be the same as the first rApp or be different from the first rApp. For example, returning to FIG. 4, the first xApp may correspond to xApp 432 and the second xApp may correspond to xApp 434, where the first rApp may correspond to rApp 422 with logical linkage (a) established between rApp 422 and xApp 432. In this regard, the second rApp may also correspond to rApp 422, such that a logical linkage (b) is established between rApp 422 and xApp 434. Alternatively, the second rApp may instead correspond to rApp 424, such that a logical linkage (c) is established between rApp 424 and xApp 434. The method then proceeds to operation S250.

At operation S250, the apparatus may be configured to identify a conflict between the first policy and the second policy. The conflict may include any kinds of conflicts that occur between the implementation of the first policy by the first xApp and the second policy by the second xApp.

For example, the first xApp may implement the first policy to modify a configuration of an E2 node for load balancing during high traffic, while the second xApp may implement the second policy to modify the configuration of the same E2 node to maintain energy saving target at the same time. The method then proceeds to operation S260.

At operation S260, the apparatus may be configured to determine a strategy for the first xApp and the second xApp to implement the first policy and the second policy, respectively. The apparatus may be configured to determine the strategy based on the priority of the first policy and the priority of the second policy.

According to example embodiments, the strategy may include configuring the first xApp to implement the first policy, and configuring the second xApp to defer implementation of the second policy. According to example embodiments, the strategy may include configuring the first xApp to implement the first policy, and configuring the second xApp to cancel implementation of the second policy.

For example, the priority of the first policy may correspond to the first level specifying that the first policy can pre-empt all other policies, while the priority of the second policy may correspond to the third level specifying that the second policy can be deferred but cannot be cancelled. Accordingly, the apparatus may configure the first xApp to implement the first policy, and configure the second xApp to defer implementation of the second policy.

In another example, the priority of the first policy may correspond to the second level specifying that the first policy cannot be deferred or be cancelled, while the priority of the second policy may correspond to the fourth level specifying that the second policy can be deferred or cancelled. Accordingly, the apparatus may configure the first xApp to implement the first policy, and configure the second xApp to cancel implementation of the second policy.

It is understood that the apparatus may be configured to also perform any additional determination associated with the strategy. For example, the apparatus may be configured to determine an amount of time to defer a policy.

Upon performing operation S260, the method 200 may be ended or be terminated. Alternatively, method 200 may return to operation S210, such that the apparatus may be configured to repeatedly perform, for at least a predetermined amount of time, the receiving the first policy and the priority of the first policy (at operation S210), the determining the first xApp (at operation S220), the receiving the second policy and the priority of the second policy (at operation S230), the determining the second xApp (at operation S240), the identifying the conflict (at operation S250), and the determining the strategy (at operation S260).

For example, the apparatus may further receive a third policy and the priority of the third policy, and then perform the determining the third xApp (similar to operation S220/S240), the identifying the conflict (at operation S250; between the third policy and the first/second policy), and the determining the strategy (at operation S260).

In view of the above, by having the Near-RT RIC receive context information of a policy (i.e., priority) from the rApp/SMO and establishing a logical linkage between the xApp and the rApp associated with such policy, the above processes enable the Near-RT RIC to be aware of the context associated with such policy and appropriately coordinate and determine a strategy on how the policy should be implemented to avoid conflicts in view of such context.

Accordingly, the above processes allow for detection and management of conflicts at the Near-RT RIC/xApp level, thereby ensuring that all conflicts can be appropriately managed and reduced to minimize impact on network performance and quality of service (QoS).

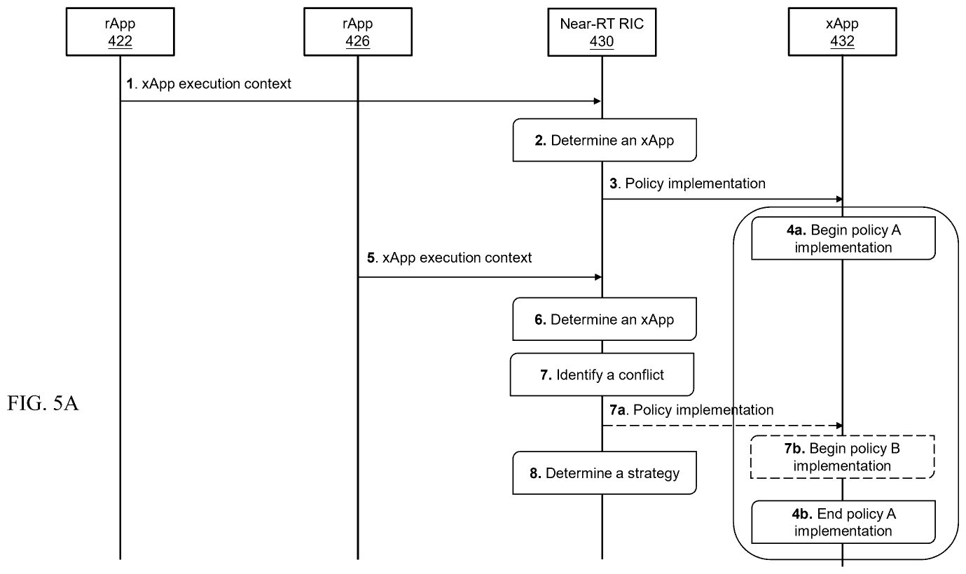

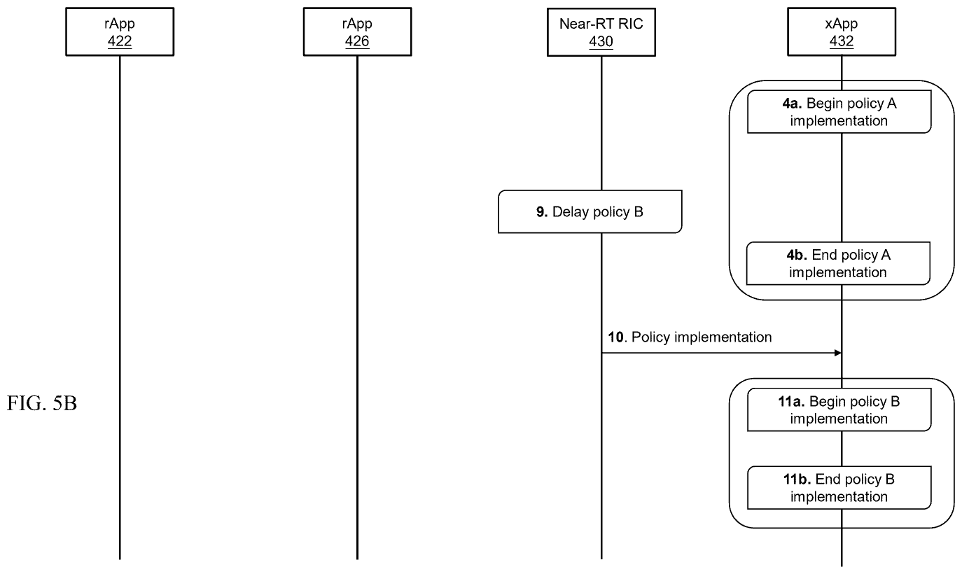

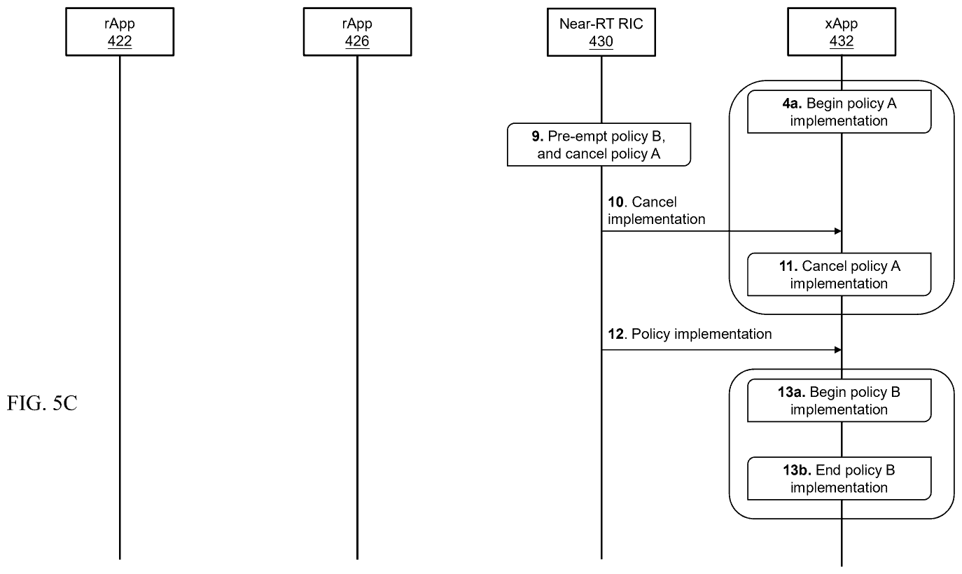

FIG. 5A to FIG. 5C illustrate a flow sequence of an example use case for managing conflicts, according to one or more example embodiments. As shown in FIG. 5A to FIG. 5C, the flow sequence may involve an rApp 422, an rApp 426, a Near-RT RIC 430, and an xApp 432. The rApp 422, the rApp 426, the Near-RT RIC 430, and the xApp 432 may be similar to the rApp 422, the rApp 426, the Near-RT RIC 430, and the xApp 432 described above in relation to FIG. 1 and FIG. 4. Further, one or more operations in FIG. 5A to FIG. 5C may involve or may be part of one or more operations described above with reference to FIG. 2.

Referring to FIG. 5A, at step 1, the rApp 422 may transmit an xApp execution context to the Near-RT RIC 430, where such xApp execution context may specify policy A and a priority of policy A, in the similar manner as described above in relation to operation S210 in method 200. The xApp execution context may be transmitted to the Near-RT RIC 430 via the A1 interface.

At step 2, the Near-RT RIC 430 may determine an xApp to implement policy A, in the similar manner as described above in relation to operation S220 in method 200. In this regard, the determined xApp may correspond to xApp 432.

At step 3, the Near-RT RIC 430 may transmit a policy implementation instructions to the xApp 432, where the xApp 432 may then begin implementation of policy A at step 4a. Here, the implementation of policy A may begin at step 4a and continues until the end of the implementation of policy A at step 4b. The policy implementation instructions may be transmitted to the xApp 432 via the xApp API. It is understood that the xApp 432 may implement policies via an E2 node (O-DU, O-CU, and the like) using the E2 interface, and may utilize subscription mechanisms to implement the policies.

At step 5, the rApp 426 may transmit an xApp execution context to the Near-RT RIC 430, where such xApp execution context may specify policy B and a priority of policy B, in the similar manner as described above in relation to operation S230 in method 200. The xApp execution context may be transmitted to the Near-RT RIC 430 via the A1 interface.

At step 6, the Near-RT RIC 430 may determine an xApp to implement policy B, in the similar manner as described above in relation to operation S240 in method 200. In this regard, the determined xApp may also correspond to xApp 432.

At step 7, the Near-RT RIC 430 may identify a conflict between the implementation of policy A and policy B in real time, in the similar manner as described above in relation to operation S250 in method 200.

For example, the xApp 432 may implement policy A to modify a configuration of an E2 node for load balancing during high traffic where such implementation occurs during a period from step 4a to step 4b. In this regard, at step 7, the Near-RT RIC 430 may identify that, in order for xApp 432 to implement policy B, xApp 432 may need to modify the configuration of the same E2 node to maintain energy saving target. However, at this time, the implementation of policy A by the xApp 432 is not yet completed, and the implementation of policy B by the xApp 432 at this time would cause conflict as shown in dotted steps 7a and 7b.

At step 8, the Near-RT RIC 430 may determine a strategy for implementing policy A and policy B, in the similar manner as described above in relation to operation S260 in method 200.

For example, referring now to FIG. 5B, the Near-RT RIC 430 may identify that the priority level of policy A corresponds to the second level specifying that policy A cannot be deferred or cancelled, while the priority of policy B corresponds to the third level specifying that policy B can be deferred but cannot be cancelled.

Accordingly, at step 9, the Near-RT RIC 430 may determine a strategy to allow the xApp 432 to continue implementing policy A, and defer implementation of policy B until the implementation of policy A has ended.

In this regard, once the implementation of policy A has ended at step 4b, the Near-RT RIC 430 may transmit a policy implementation instructions to the xApp 432 at step 10, where the xApp 432 may then begin implementation of policy B at step 11a. The policy implementation instructions may be transmitted to the xApp 432 via the xApp API. Here, the implementation of policy B may begin at step 11a and continues until the end of the implementation of policy B at step 11b.

Alternatively, referring now to FIG. 5C, the Near-RT RIC 430 may identify that the priority of policy B corresponds to the first level specifying that policy B can pre-empt all other policies, while the priority of policy A corresponds to the fourth level specifying that policy A can be deferred or cancelled.

Accordingly, at step 9, the Near-RT RIC 430 may determine a strategy to cancel implementation of policy A, and in order to implement policy B.

In this regard, the Near-RT RIC 430 may transmit an implementation cancel instructions to the xApp 432 at step 10, where the xApp 432 may then cancel implementation of policy A at step 11. The implementation cancel instructions may be transmitted to the xApp 432 via the xApp API.

Subsequently, the Near-RT RIC 430 may transmit a policy implementation instructions to the xApp 432 at step 12, where the xApp 432 may then begin implementation of policy B at step 13a. The policy implementation instructions may be transmitted to the xApp 432 via the xApp API. Here, the implementation of policy B may begin at step 13a and continues until the end of the implementation of policy B at step 13b.

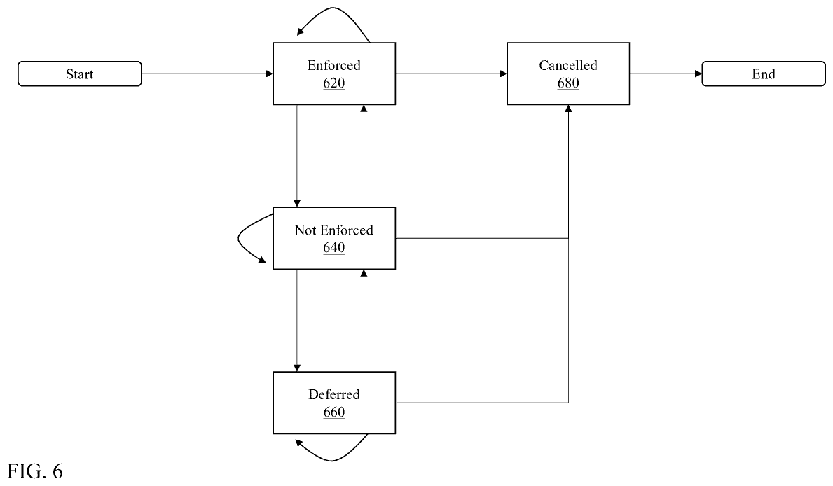

FIG. 6 illustrates an example policy state diagram, according to one or more example embodiments. As shown in FIG. 6, the policy state diagram may include at least an enforced state 620, a not enforced state 640, a deferred state 660, and a cancelled (deleted) state 680, although it is understood that the policy state diagram may include more or less states than as illustrated in FIG. 6, and/or may be arranged and specified in a manner different from as illustrated in FIG. 6, without departing from the scope of the present disclosure.

As shown in FIG. 6, once a policy is created, the policy may enter the enforced state 620, where the policy may be enforced (implemented) in the network. Here, the policy may transition into the not enforced state 640 via operations involving query policy status, feedback policy, and the like. Further, the policy may transition into the cancelled state 680 via operations involving cancellation (deletion) of the policy. Furthermore, the policy may remain in the enforced state 620 via operations involving query policy, update policy, query policy status, and the like.

Once the policy is in the not enforced state 640, the policy may transition into the enforced state 620 via operations involving update policy, query policy status, feedback policy, and the like. Further, the policy may transition into the cancelled state 680 via operations involving cancellation (deletion) of the policy. Furthermore, the policy may transition into the deferred state 660 via operations involving query policy, query policy status, and the like. Further still, the policy may remain in the not enforced state 640 via operations involving query policy, query policy status, and the like.

Once the policy is in the deferred state 660, the policy may transition into the not enforced state 640 via operations involving query policy, query policy status, and the like. Further, the policy may transition into the cancelled state 680 via operations involving cancellation (deletion) of the policy. Furthermore, the policy may remain in the deferred state 660 via operations involving query policy, query policy status, and the like.

Once the policy is in the cancelled state 680 the policy may only remain in the cancelled state 680.

### Various Aspects of Embodiments

According to example embodiments, a Near-RT RIC may be made aware of the context associated with a policy and appropriately coordinate and determine a strategy on how the policy should be implemented to avoid conflicts in view of such context, such that detection and management of conflicts at the Near-RT RIC/xApp level may be achieved, thereby ensuring that all conflicts can be appropriately managed and reduced to minimize impact on network performance and quality of service (QoS).

The foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a microservice(s) module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code-it being understood that software and hardware may be designed to implement the systems and/or methods based on the description herein.

One or more components of the apparatus of the example embodiments (e.g., Non-RT RIC, Near-RT RIC, etc.), as well as the operations associated therewith (e.g., one or more operations in FIG. 2, etc.), may be implemented in one or more systems, devices, or hardware components, such as one or more servers, and the like. In the following, descriptions of a device in which the systems or components of the example embodiments may be implemented are provided. It is contemplated that one or more operations or methods described above with reference to FIG. 2 to FIG. 6 may be performed by the device. For instance, the one or more operations or methods may be performed by at least one processor of the device upon executing machine-readable instructions or computer-readable instructions (e.g., instructions for implementing the Near-RT RIC, etc.) stored in a memory or a storage component of the device.

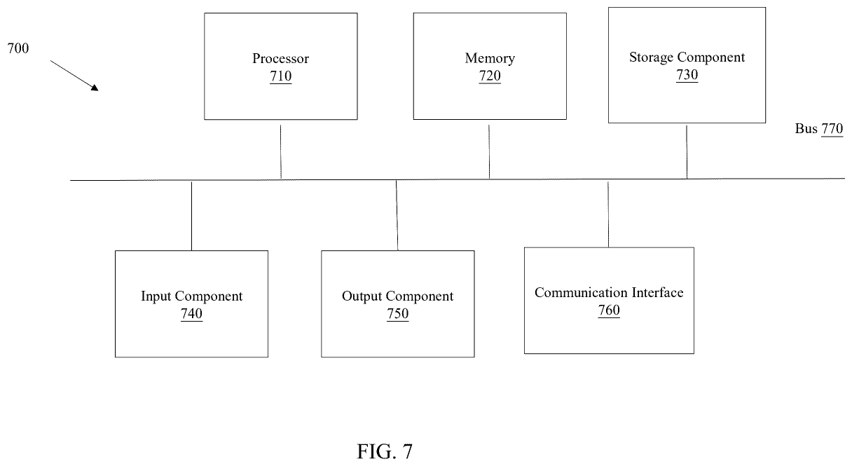

FIG. 7 illustrates an embodiment of a device 700 for implementing one or more example embodiments. As shown in FIG. 7, the device 700 includes a processor 710, a memory 720, a storage component 730, an input component 740, an output component 750, a communication interface 760, and a bus 770.

The processor 710, as used herein, means any type of computational circuit that may comprise hardware elements and software elements. The processor 710 may be embodied as a multi-core processor, a single core processor, or a combination of one or more multi-core processors and one or more single core processors, a distributed processing system, or the like. The processor 710 may be a Central Processing Unit (CPU), a graphics processing unit (GPU), an accelerated processing unit (APU), an application-specific integrated circuit (ASIC), or another type of processing component.

Memory 720 includes a non-transitory computer readable medium. Memory 720 includes a random-access memory (RAM), a read only memory (ROM), and/or another type of dynamic or static storage device (e.g., a flash memory, a magnetic memory, and/or an optical memory) that stores information and/or instructions for use by processor 710. The memory 720 comprises machine-readable instructions which are executable by the processor 710. These machine-readable instructions when executed by the processor 710 causes the processor 710 to perform one or more method steps of an embodiment described herein.

Storage component 730 stores information and/or software related to the operation and use of the device 700. For example, storage component 730 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

Input component 740 is configured to receive information, such as user input. For example, the input component 740 may include, but not be limited to, a touch screen display, a keyboard, a keypad, a mouse, a button, a switch, and/or a microphone. Additionally, or alternatively, the input component 740 may include a sensor for sensing information (e.g., a global positioning system (GPS), an accelerometer, a gyroscope, and/or an actuator).

Output component 750 is configured to provide output information from the device 700. For example, the output component 750 may be, but not limited to, a display, a speaker, an instruction device to an external device, and/or one or more light-emitting diodes (LEDs).

Communication interface 760 is an interface that provides a communication connection to other devices, such as external devices and internal devices. The connection by the communication interface 760 can be a wired connection, a wireless connection, or a combination of wired and wireless connections, and can be a direct connection or an indirect connection via a communication network that exists between the device 700 and other devices. In other words, the standard of the communication interface 760 is not limited.

The bus 770 acts as an interconnect between the processor 710, the memory 720, the storage component 730, the input component 740, the output component 750, and the communication interface 760 of the device 700. The bus 770 may include a wired interconnection or a wireless interconnection.

The number and arrangement of components shown in FIG. 7 are provided as an example. In practice, device 700 may include additional components, fewer components, different components, or differently arranged components than those shown in FIG. 7. Additionally, or alternatively, a set of components (e.g., one or more components) of device 700 may perform one or more functions described as being performed by another set of components of device 700. Further, one or more method steps described in any of the embodiments may be performed utilizing a plurality of device 700 in communication with one another.

Further, according to example embodiments, the device 700 may include one or more elements from the architecture described above in relation to FIG. 1. For example, the device 700 may include the near-real-time (Near-RT) RIC configured to implement at least one Near-RT RIC Application (xApp).

Various further respective aspects and features of embodiments of the present disclosure may be defined by the following items:
Item [1]: An apparatus that may comprise a near-real-time RIC (Near-RT RIC) that may be configured to: receive, from a first rApp, a first policy and a priority of the first policy; determine a first xApp for implementing the first policy; receive, from a second rApp, a second policy and a priority of the second policy; determine a second xApp for implementing the second policy; identify a conflict between the first policy and the second policy; and determine a strategy for the first xApp and the second xApp to implement the first policy and the second policy, respectively, based on the priority of the first policy and the priority of the second policy.
Item [2]: The apparatus according to item [1], wherein the first policy and the priority of the first policy may be specified in an xApp execution context received from the first rApp, and wherein the second policy and the priority of the second policy may be specified in an xApp execution context received from the second rApp.
Item [3]: The apparatus according to one of items [1]-[2], wherein the priority may correspond to one of a plurality of priority levels, and wherein the plurality of priority levels may include: a first level specifying that a policy can pre-empt all other policies; a second level specifying that a policy cannot be deferred or be cancelled; a third level specifying that a policy can be deferred but cannot be cancelled; and a fourth level specifying that a policy can be deferred or cancelled.
Item [4]: The apparatus according to one of items [1]-[3], wherein the strategy may include configuring the first xApp to implement the first policy, and configuring the second xApp to defer implementation of the second policy.
Item [5]: The apparatus according to one of items [1]-[4], wherein the strategy may include configuring the first xApp to implement the first policy, and configuring the second xApp to cancel implementation of the second policy.
Item [6]: The apparatus according to one of items [1]-[5], wherein the second rApp may be different from the first rApp, and wherein the second xApp may be the same as the first xApp or may be different from the first xApp.
Item [7]: The apparatus according to one of items [1]-[6], wherein the second xApp may be different from the first xApp, and wherein the second rApp may be the same as the first rApp or may be different from the first rApp.
Item [8]: A method that may include: receiving, by a near-real-time RIC (Near-RT RIC) from a first rApp, a first policy and a priority of the first policy; determining, by the Near-RT RIC, a first xApp for implementing the first policy; receiving, by the Near-RT RIC from a second rApp, a second policy and a priority of the second policy; determining, by the Near-RT RIC, a second xApp for implementing the second policy; identifying, by the Near-RT RIC, a conflict between the first policy and the second policy; and determining, by the Near-RT RIC, a strategy for the first xApp and the second xApp to implement the first policy and the second policy, respectively, based on the priority of the first policy and the priority of the second policy.
Item [9]: The method according to item [8], wherein the first policy and the priority of the first policy may be specified in an xApp execution context received by the Near-RT RIC from the first rApp, and wherein the second policy and the priority of the second policy may be specified in an xApp execution context received by the Near-RT RIC from the second rApp.
Item [10]: The method according to one of items [8]-[9], wherein the priority may correspond to one of a plurality of priority levels, and wherein the plurality of priority levels may include: a first level specifying that a policy can pre-empt all other policies; a second level specifying that a policy cannot be deferred or be cancelled; a third level specifying that a policy can be deferred but cannot be cancelled; and a fourth level specifying that a policy can be deferred or cancelled.
Item [11]: The method according to one of items [8]-[10], wherein the strategy may include configuring the first xApp to implement the first policy, and configuring the second xApp to defer implementation of the second policy.
Item [12]: The method according to one of items [8]-[11], wherein the strategy may include configuring the first xApp to implement the first policy, and configuring the second xApp to cancel implementation of the second policy.
Item [13]: The method according to one of items [8]-[12], wherein the second rApp may be different from the first rApp, and wherein the second xApp may be the same as the first xApp or may be different from the first xApp.
Item [14]: The method according to one of items [8]-[13], wherein the second xApp may be different from the first xApp, and wherein the second rApp may be the same as the first rApp or may be different from the first rApp.
Item [15]: A non-transitory computer-readable recording medium that may have recorded thereon instructions executable by an apparatus comprising a near-real-time RIC (Near-RT RIC) to cause the Near-RT RIC to perform a method including: receiving, from a first rApp, a first policy and a priority of the first policy; determining a first xApp for implementing the first policy; receiving, from a second rApp, a second policy and a priority of the second policy; determining a second xApp for implementing the second policy; determining a second xApp for implementing the second policy; identifying a conflict between the first policy and the second policy; and determining a strategy for the first xApp and the second xApp to implement the first policy and the second policy, respectively, based on the priority of the first policy and the priority of the second policy.
Item [16]: The non-transitory computer-readable recording medium according to item [15], wherein the first policy and the priority of the first policy may be specified in an xApp execution context received by the Near-RT RIC from the first rApp, and wherein the second policy and the priority of the second policy may be specified in an xApp execution context received by the Near-RT RIC from the second rApp.
Item [17]: The non-transitory computer-readable recording medium according to one of items [15]-[16], wherein the priority may correspond to one of a plurality of priority levels, and wherein the plurality of priority levels may include: a first level specifying that a policy can pre-empt all other policies; a second level specifying that a policy cannot be deferred or be cancelled; a third level specifying that a policy can be deferred but cannot be cancelled; and a fourth level specifying that a policy can be deferred or cancelled.
Item [18]: The non-transitory computer-readable recording medium according to one of items [15]-[17], wherein the strategy may include configuring the first xApp to implement the first policy, and configuring the second xApp to defer implementation of the second policy.
Item [19]: The non-transitory computer-readable recording medium according to one of items [15]-[18], wherein the strategy may include configuring the first xApp to implement the first policy, and configuring the second xApp to cancel implementation of the second policy.
Item [20]: The non-transitory computer-readable recording medium according to one of items [15]-[19], wherein the second rApp may be different from the first rApp, and wherein the second xApp may be the same as the first xApp or may be different from the first xApp.

It is understood that numerous modifications and variations of the present disclosure are possible in light of the above teachings. It will be apparent that within the scope of the appended clauses, the present disclosures may be practiced otherwise than as specifically described herein.

What is claimed is:

1. An apparatus comprising:
a near-real-time RIC (Near-RT RIC) configured to:
receive, from a first rApp, a first policy and a priority of the first policy;
determine a first xApp for implementing the first policy;
receive, from a second rApp, a second policy and a priority of the second policy;
determine a second xApp for implementing the second policy;
identify a conflict between the first policy and the second policy; and
determine a strategy for the first xApp and the second xApp to implement the first policy and the second policy, respectively, based on the priority of the first policy and the priority of the second policy.

2. The apparatus according to claim 1, wherein the first policy and the priority of the first policy are specified in an xApp execution context received from the first rApp, and wherein the second policy and the priority of the second policy are specified in an xApp execution context received from the second rApp.

3. The apparatus according to claim 1, wherein the priority corresponds to one of a plurality of priority levels, and wherein the plurality of priority levels comprise:
a first level specifying that a policy can pre-empt all other policies;
a second level specifying that a policy cannot be deferred or be cancelled;
a third level specifying that a policy can be deferred but cannot be cancelled; and
a fourth level specifying that a policy can be deferred or cancelled.

4. The apparatus according to claim 1, wherein the strategy comprises configuring the first xApp to implement the first policy, and configuring the second xApp to defer implementation of the second policy.

5. The apparatus according to claim 1, wherein the strategy comprises configuring the first xApp to implement the first policy, and configuring the second xApp to cancel implementation of the second policy.

6. The apparatus according to claim 1, wherein the second rApp is different from the first rApp, and wherein the second xApp is the same as the first xApp or is different from the first xApp.

7. The apparatus according to claim 1, wherein the second xApp is different from the first xApp, and wherein the second rApp is the same as the first rApp or is different from the first rApp.

8. A method comprising:
receiving, by a near-real-time RIC (Near-RT RIC) from a first rApp, a first policy and a priority of the first policy;
determining, by the Near-RT RIC, a first xApp for implementing the first policy;
receiving, by the Near-RT RIC from a second rApp, a second policy and a priority of the second policy;
determining, by the Near-RT RIC, a second xApp for implementing the second policy;
identifying, by the Near-RT RIC, a conflict between the first policy and the second policy; and
determining, by the Near-RT RIC, a strategy for the first xApp and the second xApp to implement the first policy and the second policy, respectively, based on the priority of the first policy and the priority of the second policy.

9. The method according to claim 8, wherein the first policy and the priority of the first policy are specified in an xApp execution context received by the Near-RT RIC from the first rApp, and wherein the second policy and the priority of the second policy are specified in an xApp execution context received by the Near-RT RIC from the second rApp.

10. The method according to claim 8, wherein the priority corresponds to one of a plurality of priority levels, and wherein the plurality of priority levels comprise:
a first level specifying that a policy can pre-empt all other policies;
a second level specifying that a policy cannot be deferred or be cancelled;
a third level specifying that a policy can be deferred but cannot be cancelled; and
a fourth level specifying that a policy can be deferred or cancelled.

11. The method according to claim 8, wherein the strategy comprises configuring the first xApp to implement the first policy, and configuring the second xApp to defer implementation of the second policy.

12. The method according to claim 8, wherein the strategy comprises configuring the first xApp to implement the first policy, and configuring the second xApp to cancel implementation of the second policy.

13. The method according to claim 8, wherein the second rApp is different from the first rApp, and wherein the second xApp is the same as the first xApp or is different from the first xApp.

14. The method according to claim 8, wherein the second xApp is different from the first xApp, and wherein the second rApp is the same as the first rApp or is different from the first rApp.

15. A non-transitory computer-readable recording medium having recorded thereon instructions executable by an apparatus comprising a near-real-time RIC (Near-RT RIC) to cause the Near-RT RIC to perform a method comprising:
receiving, from a first rApp, a first policy and a priority of the first policy;
determining a first xApp for implementing the first policy;
receiving, from a second rApp, a second policy and a priority of the second policy;
determining a second xApp for implementing the second policy;
identifying a conflict between the first policy and the second policy; and
determining a strategy for the first xApp and the second xApp to implement the first policy and the second policy, respectively, based on the priority of the first policy and the priority of the second policy.

16. The non-transitory computer-readable recording medium according to claim 15, wherein the first policy and the priority of the first policy are specified in an xApp execution context received by the Near-RT RIC from the first rApp, and wherein the second policy and the priority of the second policy are specified in an xApp execution context received by the Near-RT RIC from the second rApp.

17. The non-transitory computer-readable recording medium according to claim 15, wherein the priority corresponds to one of a plurality of priority levels, and wherein the plurality of priority levels comprise:
a first level specifying that a policy can pre-empt all other policies;
a second level specifying that a policy cannot be deferred or be cancelled;
a third level specifying that a policy can be deferred but cannot be cancelled; and
a fourth level specifying that a policy can be deferred or cancelled.

18. The non-transitory computer-readable recording medium according to claim 15, wherein the strategy comprises configuring the first xApp to implement the first policy, and configuring the second xApp to defer implementation of the second policy.

19. The non-transitory computer-readable recording medium according to claim 15, wherein the strategy comprises configuring the first xApp to implement the first policy, and configuring the second xApp to cancel implementation of the second policy.

20. The non-transitory computer-readable recording medium according to claim 15, wherein the second rApp is different from the first rApp, and wherein the second xApp is the same as the first xApp or is different from the first xApp.
